(19) United States
(12) Patent Application Publication
(10) Pub. No.: US 2008/0248290 A1
(43) Pub. Date: Oct. 9, 2008

(54) METHOD FOR SURFACE TREATMENT OF SHELLS

(75) Inventors: Che-Yuan HSU, Taipei Hsien (TW); Ken-Holm HANSEN, Farevejle (DK)

Correspondence Address: PCE INDUSTRY, INC.;ATT. CHENG-JU CHIANG, 458 E. LAMBERT ROAD, FULLERTON, CA, 92835, US

(73) Assignee: SUTECH TRADING LIMITED, Tortola (VG)

(21) Appl. No.: 11/769,660

(22) Filed: Jun. 27, 2007

(30) Foreign Application Priority Data
Apr. 6, 2007 (CN) 200710073959.8

(51) Int. Cl. B05D 1/00; B05D 3/02; B32B 33/00

(52) U.S. Cl. 428/332; 427/372.2; 427/402

(57) ABSTRACT

A method for producing a shell (100) with three-dimensional decoration, via a surface treatment process, is provided. The method includes four steps as follows. A base body (10) of the shell is firstly formed or otherwise provided. A base-coat layer (20) is then sprayed and formed on an exterior surface (12) of the base body. After that, an ink layer (30) is printed onto the base-coat layer. Finally, a protecting top-coat layer (40) is sprayed and formed upon the ink layer and the base-coat layer in such a manner that the ink layer is thereby enclosed within a combination of the base-coat layer and the top-coat layer.

### BACKGROUND OF THE INVENTION

1. Field of the Invention

The present invention relates to a method for surface treatment of shells and, particularly, to a method for surface treating a shell with a three-dimensionally decorated surface.

2. Description of Related Art

Shells are widely used in many technological fields. One example is a shell used with a portable electronic device (e.g., a mobile phone) for shielding internal electronic components. Another example is a shell used with a piece of furniture (e.g., a mini sofa) to provide decoration.

Typically, a shell used for the portable electronic device is decorated by in-mold decoration (IMD). Specifically, an exterior surface of the shell is in-mold decorated to provide a three-dimensional figure/texture and decorative appearance. However, treatment of in-mold decoration is generally complicated and thus tends to be quite expensive.

Therefore, a heretofore-unaddressed need exists in the art to address the aforementioned deficiencies and inadequacies.

### SUMMARY

In one aspect, a method for surface treatment of shells with three-dimensional decoration is provided. The method includes four steps, as follows. A base body of the shell is firstly formed, and a base-coat layer is then sprayed and formed on an exterior surface of the base body. After that, an ink layer is selectably printed on the base-coat layer. Finally, a top-coat layer is sprayed and formed in such a manner that the ink layer is enclosed within the base-coat layer and the top-coat layer.

Moreover, a shell with a three-dimensional appearance is surface-treated and thereby yielded by the present method. The shell includes a base body, a base-coat layer, an ink layer, and a top-coat layer. The base-coat layer is formed on an exterior surface of the base body. The ink layer is selectably formed on the base-coat layer and is enclosed within a combination of the base-coat layer and the top-coat layer.

In another aspect, a method for producing shells with three-dimensional decoration is provided. The method includes three steps, as follows. A base body of the shell is firstly formed. An ink layer is then selectably printed on an exterior surface of the base body. Finally, a top-coat layer is sprayed and formed thereon in such a manner that the ink layer is enclosed within a combination of the exterior surface and the top-coat layer.

Furthermore, a shell with three-dimensional decoration is created using the present method. The shell includes a base body, an ink layer, and a top-coat layer. The ink layer is selectively formed on an exterior surface of the base body and is enclosed within a combination of the exterior surface and the top-coat layer.

In another aspect, the shell, manufactured by implementing the aforementioned method, is provided. The shell includes an exterior surface. The exterior surface has a grippable portion formed thereon.

### BRIEF DESCRIPTION OF THE DRAWINGS

Many aspects of method for surface treatment of shells can be better understood with reference to the following drawings. These drawings are not necessarily drawn to scale, the emphasis instead being placed upon clearly illustrating the principles of the present method for surface treatment of shells. Moreover, in the drawings like reference numerals designate corresponding parts throughout the several views. Wherever possible, the same reference numbers are used throughout the drawings to refer to the same or like elements of an embodiment, and wherein:

FIG. 1 is a sectional, side view of a shell, in accordance with a present embodiment;

FIG. 2 is a sectional, side view of the base body of the shell shown in FIG. 1;

FIG. 3 is a sectional, side view of a base-coat layer combined with the base body of the shell shown in FIG. 2; and

FIG. 4 is sectional, side view of an ink layer combined with the base body and the base-coat layer of the shell shown in FIG. 3.

### DETAILED DESCRIPTION OF PREFERRED EMBODIMENTS

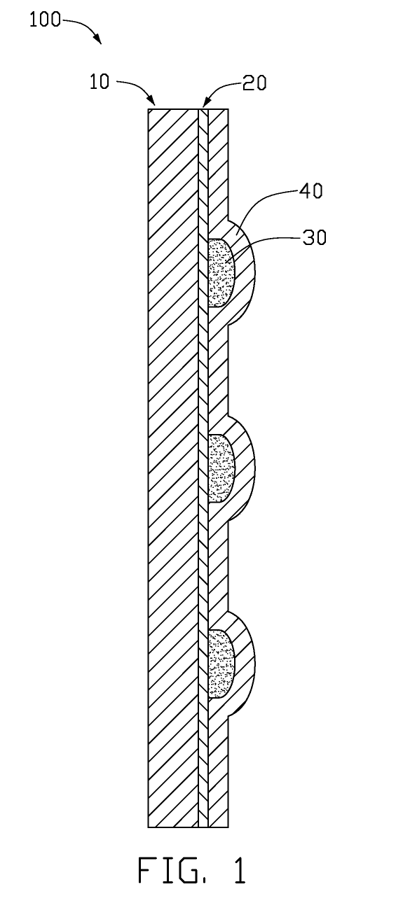

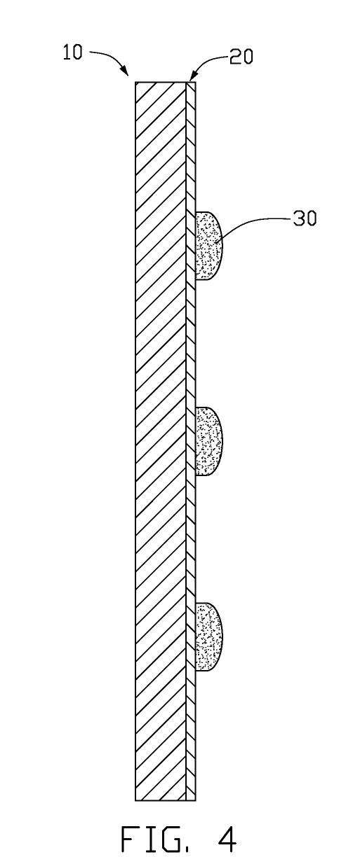

The present method for surface treatment of a shell is described here in conjunction with the accompanying drawings in FIGS. 1-4. The shell is usable in many fields and can be made of metal, plastic, or otherwise, so long as the material is sufficiently durable and/or abrasion resistant for its intended purpose (e.g., a shell may need to protect interior parts and maintain a decorative appearance). Beneficially, the shell is made of metal when incorporated in a portable electronic device, such as a mobile phone, a digital camera, or the like, to sufficiently protect any interior electronics and/or optics.

Referring to FIG. 1, the shell 100 can, for example, be used to shield and retain electronic components (e.g., a printed circuit board and a transducer) of a portable electronic device. The shell 100 includes a base body 10, a base-coat layer 20, an ink layer 30, and a top-coat layer 40. Advantageously, the base-coat layer 20, the ink layer 30, and the top-coat layer 40 are respectively applied, in order, onto an exterior surface 12 of the base body 10 by the present surface treatment method. The exterior surface 12 can, e.g., be a planar surface (shown in FIG. 1) or a curved surface with a low degree of curvature.

The base-coat layer 20, advantageously provided with at least one particular color, is, usefully, applied and baked directly onto on the exterior surface 12 of the base body 10. The ink layer 30 is further selectably printed directly onto the base-coat layer 20 in a particular shape/pattern and with at least one particular color. The ink layer 30 is, quite suitably, more than 0.15 mm thick to create a raised appearance and to thus enhance the texture and appearance of the resultant shell 100. Thus, the ink layer 30 combined with the base body 10 and the base-coat layer 20 gives an apparent three-dimensional, decorative effect. This decorative effect can be increased by adjusting the color of the ink layer 30 relative to that of the base-coat layer 20. It is to be understood that such adjusting of the color could involve matching and/or contrasting the color of selected portions of the ink layer 30 with respect to the base-coat coloration to achieve the desired appearance.

The top-coat layer 40 is, advantageously, formed/deposited and baked directly onto the exposed external surfaces of the ink layer 30 and the base-coat layer 20. In other words, the ink layer 30 is enclosed between the top-coat layer 40 and the base-coat layer 20. The top-coat layer 40 is used to help prevent the ink layer 30 from being removed, for example by abrasion, from the shell 100. The top-coat layer 40 should, usefully, be transparent to permit the underlying colorations to be most optimally viewed.

It is to be understood that the base-coat layer 20 can be omitted, and, in such an instance, the ink layer 30 directly printed onto the exterior surface 12 of the base body 10 and instead be enclosed within the exterior surface 12 and the top-coat layer 40. It is to be further understood that any various known coating methods and preparation techniques may be used to produce any of the base-coat layer 20, the ink layer 30, and/or the top-coating layer 40, so long as a suitable appearance and surface durability is achieved.

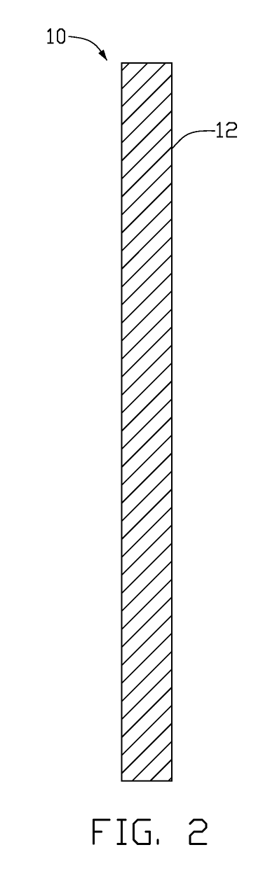

Referring also to FIG. 2-4, the method for using surface treatment to form a shell 100 with three-dimensional decoration thereon includes steps as follows. FIG. 2-4 each show a step in the method for forming the shell 100 with three-dimensional decoration thereon.

Referring to FIG. 2, the first step is to form/provide the base body 10 of the shell 100. In the preferred embodiment, the base body 10 is made of metal. The base body 10 can be formed by any of various kinds of metal forming technology. In a beneficial embodiment, the base shell is formed by punching.

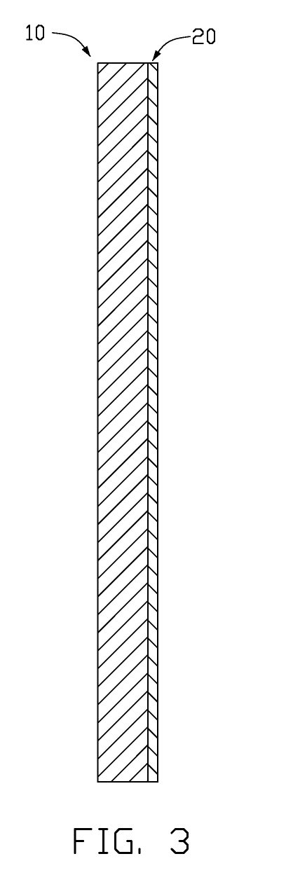

Referring to FIG. 3, a step includes spraying on and forming the base- coat layer 20 on the exterior surface 12 of the base body 10. Advantageously, the treatment of spraying and coating can incorporate a conventional baking finish treatment upon application of the coating material. The process of the baking finish is well known to a person with an ordinary skill in the art.

Referring to FIG. 3, then, the ink layer 30 is selectably deposited in a particular shape/pattern. During this step, a screen-printing machine (not shown) combined with a screen plate (not shown) is used, for example, to screen print the ink layer 30 on the base-coat layer 20. It is to be understood, however, any printing or coating method that facilitates the formation of a particular shape/pattern could be employed.

After that, referring back to FIG. 1, the top-coat layer 40 is sprayed upon/over and applied so as to cover the ink layer 30 and the base-coat layer 20. In a beneficial embodiment, the top-coat layer 40, upon application thereof, is subjected to a conventional baking finish treatment.

It is also to be understood that, with the base-coat layer 20 being omitted, the step of treating the base-coat layer 20 can also be omitted. During the step of treating the ink layer 30, the ink layer 30 can instead be directly screen printed onto the exterior surface 12 of the base body 10.

Therefore, the shell 100 is finally formed by the present method. The exterior surface 12 of the base body 10 has the base-coat layer 20, the ink layer 30 with a three-dimensional figure, and the transparent top-coat layer 40 formed thereon for giving a three-dimensional appearance. This as-coated base body 10 serves as the present shell 100. In particular, colors of the ink layer 30 and the base-coat layer 20 can be adjusted (i.e., matched and/or contrasted, as desired) in a predetermined manner so that the three-dimensional appearance of the shell can be more attractive. The top-coat layer 40 serves to protect the underlying surfaces and/or layers, particularly helping to prevent the abrasion/wear of the ink layer 30. As such, the method for forming the present shell 100 is simpler to carry out, compared with the typical in-mold decoration. Thus, the aforementioned method is relatively cheap.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming a shell with a three-dimensional appearance, the method comprising the steps of:
providing a base body of the shell, the base body having an exterior base surface;
creating a base-coat layer on the exterior base surface;
depositing an ink layer selectably on the base-coat layer, thereby yielding exposed base-coat portions and exposed ink portions; and
forming a top-coat layer on the exposed base-coat portions and the exposed ink portions in such a manner that the ink layer is enclosed within a combination of the base-coat layer and the top-coat layer.

2. The method as claimed in claim 1, wherein the ink layer has a thickness greater than about 0.15 mm.

3. The method as claimed in claim 1, wherein the step of depositing the ink layer is achieved using a screen printing machine combined with a screen plate.

4. The method as claimed in claim 1, wherein the base-coat layer, upon creation thereof, is baked onto the exterior surface of the base body.

5. The method as claimed in claim 1, wherein the top-coat layer, after formation thereof, is baked onto the base-coat layer and the ink layer.

6. A method for manufacturing a shell with a three-dimensional appearance, the method comprising the steps of:
providing a base body having an exterior surface;
printing an ink layer on the exterior surface of the base body; and
forming a top-coat layer in such a manner that the ink layer is enclosed between the exterior surface of the base body and the top-coat layer.

7. The method as claimed in claim 6, wherein the ink layer has a thickness greater than about 0.15 mm.

8. The method as claimed in claim 6, wherein the ink layer is provided in a particular pattern.

9. The method as claimed in claim 6, wherein the step of printing the ink layer is achieved using a screen-printing machine combined with a screen plate.

10. The method as claimed in claim 6, wherein the top-coat layer is, once formed, baked onto the base-coat layer and the ink layer.

11. A shell, provided with a three-dimensional appearance, comprising:
a base body;
a base-coat layer formed on an exterior surface of the base body;
an ink layer formed on the base-coat layer; and
a top-coat layer formed upon the base-coat layer and the ink layer in such a manner that the ink layer is enclosed between the base-coat layer and the top-coat layer.

12. The shell as claimed in claim 11, wherein the ink layer has a thickness greater than about 0.15 mm.

13. The shell as claimed in claim 11, wherein the exterior surface of the base body is planar or is curved with a low degree of arc.

14. The shell as claimed in claim 11, wherein the top-coat layer is transparent.

15. A shell, provided with a three-dimensional appearance, comprising:
a base body;
an ink layer formed on the base body; and
a top-coat layer formed on the base body and the ink layer, the top-coat thereby protecting the ink layer.

16. The shell as claimed in claim 15, wherein the ink layer has a thickness more than about 0.15 mm.

17. The shell as claimed in claim 15, wherein the top-coat layer is transparent.
